(19) United States
(12) Patent Application Publication
(10) Pub. No.: US 2025/0373629 A1
(43) Pub. Date: Dec. 4, 2025

(54) SYSTEM AND METHOD FOR ADAPTIVE INTRUSION DETECTION IN NETWORK ENVIRONMENTS

(71) Applicant: Technology Innovation Institute - Sole Proprietorship LLC, Masdar City, (AE)

(72) Inventors: Bassem Ouni, Abu Dhabi (AE); Reda Alami, Abu Dhabi (AE); Hakim Hacid, Abu Dhabi (AE)

(73) Assignee: Technology Innovation Institute - Sole Proprietorship LLC, Masdar City (AE)

(21) Appl. No.: 19/207,802

(22) Filed: May 14, 2025

Related U.S. Application Data
(60) Provisional application No. 63/654,184, filed on May 31, 2024.

(51) Int. Cl. H04L 9/40

(52) U.S. Cl. CPC H04L 63/1416

(57) ABSTRACT

The disclosed system and method pertain to intrusion detection in network environments. The method involves deploying multiple agents in distinct network segments, each equipped with a reinforcement learning algorithm. These agents observe their localized environment, generate hidden states, and calculate attention weights to form an aggregated state. Based on this aggregated state and their hidden state, agents make decisions on potential attacks and generate request vectors for information from other agents. Agents communicate these vectors, receive hidden states from other agents, update their aggregated states, and refine their decisions. Action vectors are formed based on these decisions and request vectors and compiled into a global action matrix. Agents use outcomes and feedback to refine their internal models, enhancing future detection and communication actions.

### CROSS-REFERENCE TO RELATED APPLICATIONS

This application claims priority to U.S. Provisional Application No. 63/654,184, filed May 31, 2024, which is incorporated by reference in its entirety.

### FIELD OF INVENTION

The present disclosure generally relates to the field of cybersecurity, specifically to methods and systems for intrusion detection in network environments, particularly in Internet of Things (IoT) networks, using multi-agent reinforcement learning algorithms and attention mechanisms.

### BACKGROUND

The Internet of Things (IoT) refers to the network of physical devices, vehicles, home appliances, and other items embedded with electronics, software, sensors, actuators, and connectivity which enables these objects to connect and exchange data. The IoT involves extending Internet connectivity beyond standard devices, such as desktops, laptops, smartphones and tablets, to any range of traditionally non-internet-enabled physical devices and everyday objects. These devices can communicate and interact over the Internet, and they can be remotely monitored and controlled.

As the IoT continues to grow, so does the complexity and heterogeneity of network topologies and interactions. This complexity increases the potential attack surface for cyber threats, which are becoming increasingly sophisticated and fluid in nature. The heterogeneity of IoT devices and their intercommunications further exacerbates this issue.

### SUMMARY OF INVENTION

In one aspect, the present disclosure relates to a method of detecting an intrusion attack to a computing network, comprising initiating by a node of the computing network a distributed intrusion detection agent, the distributed intrusion detection agent configured to communicate with a plurality of other distributed intrusion detection agents executing across a plurality of other nodes of the computing network, each of the node and the plurality of other nodes assigned to distinct network segments of the computing network monitoring by the distributed intrusion detection agent network activity of a network segment assigned to the distributed intrusion detection agent generating by the distributed intrusion detection agent an initial action vector using one or more reinforcement learning techniques, the initial action vector comprising a first indication of whether an attack was detected and a second indicating defining a subset of the plurality of other nodes the node requires further information from broadcasting by the distributed intrusion detection agent the initial action vector across the computing network receiving by the distributed intrusion detection agent the further information from the subset of the plurality of other nodes and updating by the distributed intrusion detection agent the initial action vector based on the further information to generate an updated action vector comprising an updated first indication of whether an attack was detected.

In embodiments of this aspect, the disclosed method according to any of the above example embodiments, wherein generating by the distributed intrusion detection agent the initial action vector comprises generating via a recurrent neural network a hidden state based on the network activity of the network segment assigned to the distributed intrusion detection agent, the hidden state representing a current understanding of the network activity based on previous observed states.

In embodiments of this aspect, the disclosed method according to any of the above example embodiments, further comprising receiving a plurality of other hidden states from the plurality of other distributed intrusion detection agents in the computing network.

In embodiments of this aspect, the disclosed method according to any of the above example embodiments, further comprising leveraging an attention mechanism comprising a Softmax layer and an aggregation layer to focus on specific hidden states from the plurality of other distributed intrusion detection agents, wherein the attention mechanism generates a weighted combination of the hidden state and the plurality of other hidden states.

In embodiments of this aspect, the disclosed method according to any of the above example embodiments, wherein generating by the distributed intrusion detection agent the initial action vector comprises determining a probability of an attack being detected based on the network activity.

In embodiments of this aspect, the disclosed method according to any of the above example embodiments, further comprising receiving by the distributed intrusion detection agent a plurality of other updated action vectors from the plurality of other distributed intrusion detection agents.

In embodiments of this aspect, the disclosed method according to any of the above example embodiments, further comprising updating and refining by the distributed intrusion detection agent the one or more reinforcement learning techniques based on the plurality of other updated action vectors.

In one aspect, the present disclosure relates to a non-transitory computer readable medium comprising programming instructions, which, when executed by a processor, causes a node of a computing network to perform operations comprising initiating by the node of the computing network a distributed intrusion detection agent, the distributed intrusion detection agent configured to communicate with a plurality of other distributed intrusion detection agents executing across a plurality of other nodes of the computing network, each of the node and the plurality of other nodes assigned to distinct network segments of the computing network monitoring by the distributed intrusion detection agent network activity of a network segment assigned to the distributed intrusion detection agent generating by the distributed intrusion detection agent an initial action vector using one or more reinforcement learning techniques, the initial action vector comprising a first indication of whether an attack was detected and a second indicating defining a subset of the plurality of other nodes the node requires further information from broadcasting by the distributed intrusion detection agent the initial action vector across the computing network receiving by the distributed intrusion detection agent the further information from the subset of the plurality of other nodes and updating by the distributed intrusion detection agent the initial action vector based on the further information to generate an updated action vector comprising an updated first indication of whether an attack was detected.

In embodiments of this aspect, the disclosed non-transitory computer readable medium according to any of the above example embodiments, wherein generating by the distributed intrusion detection agent the initial action vector comprises generating via a recurrent neural network a hidden state based on the network activity of the network segment assigned to the distributed intrusion detection agent, the hidden state representing a current understanding of the network activity based on previous observed states.

In embodiments of this aspect, the disclosed non-transitory computer readable medium according to any of the above example embodiments, further comprising receiving a plurality of other hidden states from the plurality of other distributed intrusion detection agents in the computing network.

In embodiments of this aspect, the disclosed non-transitory computer readable medium according to any of the above example embodiments, further comprising leveraging an attention mechanism comprising a Softmax layer and an aggregation layer to focus on specific hidden states from the plurality of other distributed intrusion detection agents, wherein the attention mechanism generates a weighted combination of the hidden state and the plurality of other hidden states.

In embodiments of this aspect, the disclosed non-transitory computer readable medium according to any of the above example embodiments, wherein generating by the distributed intrusion detection agent the initial action vector comprises determining a probability of an attack being detected based on the network activity.

In embodiments of this aspect, the disclosed non-transitory computer readable medium according to any of the above example embodiments, further comprising receiving by the distributed intrusion detection agent a plurality of other updated action vectors from the plurality of other distributed intrusion detection agents.

In embodiments of this aspect, the disclosed non-transitory computer readable medium according to any of the above example embodiments, further comprising updating and refining by the distributed intrusion detection agent the one or more reinforcement learning techniques based on the plurality of other updated action vectors.

In one aspect, the present disclosure relates to a system comprising a processor and a memory comprising a distributed intrusion detection agent configured to communicate with a plurality of other distributed intrusion detection agents executing across a plurality of other nodes of a computing network, each of the distributed intrusion detection agent and the plurality of other distributed intrusion detection agents assigned to distinct network segments of the computing network and programming instructions stored thereon, the programming instructions, which, when executed by the processor, causes the distributed intrusion detection agent to perform operations comprising monitoring by the distributed intrusion detection agent network activity of a network segment assigned to the distributed intrusion detection agent generating by the distributed intrusion detection agent an initial action vector using one or more reinforcement learning techniques, the initial action vector comprising a first indication of whether an attack was detected and a second indicating defining a subset of the plurality of other intrusion detection agents the intrusion detection agent requires further information from broadcasting by the distributed intrusion detection agent the initial action vector across the computing network receiving by the distributed intrusion detection agent the further information from the subset of the plurality of other intrusion detection agents and updating by the distributed intrusion detection agent the initial action vector based on the further information to generate an updated action vector comprising an updated first indication of whether an attack was detected.

In embodiments of this aspect, the disclosed system according to any of the above example embodiments, wherein generating by the distributed intrusion detection agent the initial action vector comprises generating via a recurrent neural network a hidden state based on the network activity of the network segment assigned to the distributed intrusion detection agent, the hidden state representing a current understanding of the network activity based on previous observed states.

In embodiments of this aspect, the disclosed system according to any of the above example embodiments, further comprising receiving a plurality of other hidden states from the plurality of other distributed intrusion detection agents in the computing network and leveraging an attention mechanism comprising a Softmax layer and an aggregation layer to focus on specific hidden states from the plurality of other distributed intrusion detection agents, wherein the attention mechanism generates a weighted combination of the hidden state and the plurality of other hidden states.

In embodiments of this aspect, the disclosed system according to any of the above example embodiments, wherein generating by the distributed intrusion detection agent the initial action vector comprises determining a probability of an attack being detected based on the network activity.

In embodiments of this aspect, the disclosed system according to any of the above example embodiments, further comprising receiving by the distributed intrusion detection agent a plurality of other updated action vectors from the plurality of other distributed intrusion detection agents.

In embodiments of this aspect, the disclosed system according to any of the above example embodiments, further comprising updating and refining by the distributed intrusion detection agent the one or more reinforcement learning techniques based on the plurality of other updated action vectors.

### BRIEF DESCRIPTION OF FIGURES

So that the way the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram illustrating a computing network, according to example embodiments.

FIG. 2 is a block diagram illustrating agents deployed in a computing network, according to example embodiments.

FIG. 3 is a block diagram illustrating an individual agent in the computing network, according to example embodiments.

FIG. 4 is a flow diagram illustrating a method of addressing intrusion detection attacks in the computing network, according to example embodiments.

FIG. 5A illustrates a system bus computing system architecture, according to example embodiments.

FIG. 5B illustrates a computer system having a chipset architecture, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Intrusion Detection Systems (IDSs) are a type of security system for networks and computers. They are used to detect various types of malicious behaviors that can compromise the security and trust of computer systems. This includes network attacks against vulnerable services, data driven attacks on applications, host-based attacks such as privilege escalation, unauthorized logins and access to sensitive files, and malware (viruses, worms, and Trojan horses).

Traditional IDSs primarily rely on static rule-based paradigms and signature-driven methodologies. These systems use a set of predefined rules or patterns to detect threats. When network activity matches a predefined signature, an alert is generated, and the security team is notified. However, these traditional IDSs often falter in the face of modem cyber threats due to their reliance on fixed rule sets and signature-based detection paradigms.

Embodiments of the present disclosure introduce a Multi-Agent Reinforcement Learning-based Intrusion Detection System (MARLEIDS) designed to address the challenges of modem cybersecurity. The MARLEIDS is a technically advanced solution that leverages the power of reinforcement learning in a multi-agent setup to provide a robust and scalable blueprint for next-generation network security solutions.

Reinforcement learning is an area of machine learning where an agent learns to make decisions by taking actions in an environment to achieve a goal. The agent learns from the consequences of its actions, rather than from being explicitly taught and it selects its actions based on its past experiences (exploitation) and by new choices (exploration), which is known as the exploration vs exploitation trade-off in reinforcement learning. Rather than apply a fixed rule set or rely on signature-based detection paradigms of conventional IDSs, the present approach utilizes reinforcement learning techniques to continually learn and adapt its intrusion detection strategies.

In some cases, the MARLEIDS may be deployed in a network environment, such as an Internet of Things (IoT) network, where it can monitor and analyze collected data (e.g. network traffic) in real-time or near real-time. The system may include a plurality of agents, each assigned to distinct network segments of the network environment. Each agent within the system is tailored to monitor for specific types of attacks, such as Distributed Denial of Service (DDoS), phishing, or malware infiltration, pertinent to its assigned network segment. By specializing in detecting particular threat vectors, the agents can apply focused analytical techniques and heuristics to effectively identify and mitigate attacks that exhibit behaviors or patterns characteristic of their respective domains. Each agent may be equipped with a reinforcement learning algorithm, enabling it to continuously adapt its detection strategies based on feedback from its localized environment. The reinforcement learning algorithm employed by each agent may be a multi-agent reinforcement learning (MARL) algorithm, which facilitates collaborative learning and adaptation among the agents. This MARL framework enables agents to not just learn from their own experiences within their localized environment, but also to benefit from the collective experiences of other agents within the network. Through this collaborative approach, each agent can enhance its detection strategies by incorporating insights gained from the actions and feedback of other agents, leading to a more robust and comprehensive intrusion detection capability.

Each agent may observe its localized environment and generate a hidden state based on the observed state and a previous hidden state. The observed state may represent the current state of the network segment to which the agent is assigned, and may include various types of network data, such as packet data, network traffic data, or other relevant data. The hidden state may represent the agent's internal representation of the observed state, which may be used to guide the agent's decision-making process.

In some cases, each agent may receive vectors of hidden states from other agents in the network. The agent may calculate attention weights for each agent based on its own hidden state and the received hidden states. The attention weights may be calculated using an attention mechanism that enables the system to filter out irrelevant or redundant data, allowing agents to concentrate on pertinent information. With the attention weights, the agent may aggregate the state information from all agents to form an aggregated state.

Each agent may then decide whether an attack has been detected based on the aggregated state and its own hidden state. The decision may be made using a decision function that classifies whether an observed state represents an attack or not. Concurrently, the agent may generate a request vector indicating which agents it requires information from. The request vector may be communicated to other agents in the network through broadcast or direct communication, depending on the architecture of the network and the need for a security expert.

Upon receiving the hidden states from other agents, the agent may update its aggregated state, recalculate its attention weights, and update its decision based on the new information. If the decision changes or if there is additional relevant information, the agent may send feedback or updates to other agents. This iterative learning process allows the system to refine its decision-making over time, gradually reducing the number of false positives and ensuring that alerts are genuine threats.

With the decision and request vector, the agent may form an action vector. When all agents have generated their respective action vectors, these vectors may be compiled into a global action matrix. The global action matrix may represent the collective decision-making of all agents in the network, providing a comprehensive view of the network's security status.

Each agent may use outcomes and feedback to update and refine their internal models, improving their future detection and communication actions. This continuous learning and adaptation process allows the MARLEIDS to remain effective even as cyber threats evolve, ensuring high detection accuracy and swift threat identification.

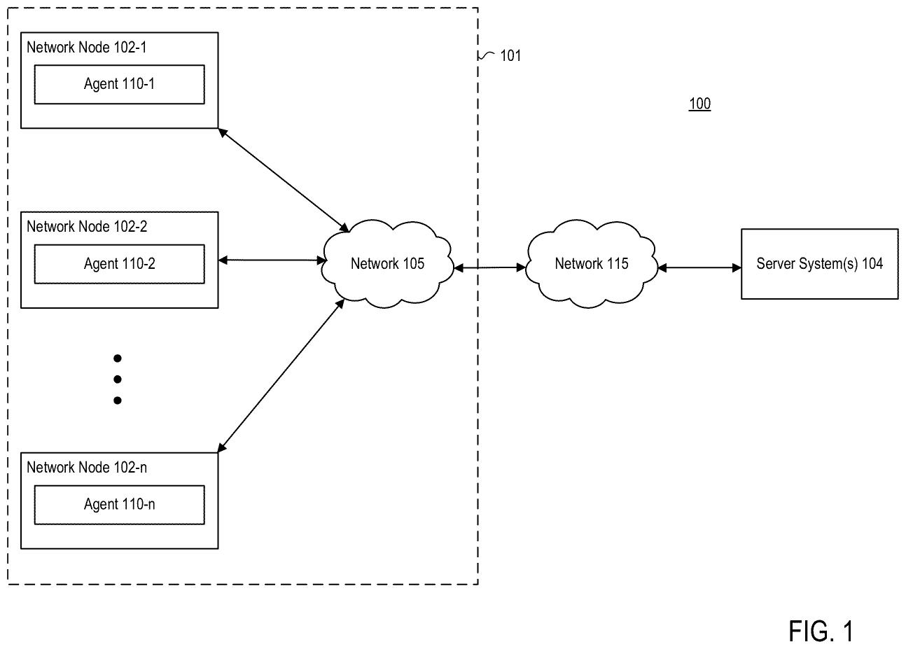

FIG. 1 is a block diagram illustrating a computing environment 100, according to example embodiments. Computing environment 100 may include a computing network 101 that includes a plurality of network nodes 102-1, 102-2, and 102-n (generally referred to as “network node 102”) communicating via local network 105. In some embodiments, the computing network 101 may communicate externally with server system 104 via network 115.

Network 105 may be representative of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may be representative of the Internet, a private data network, virtual private network using a public network and/or other suitable connection(s) that enables components in computing environment 100 to send and receive information between the components of computing environment 100.

Each network node 102 may be representative of one or more computing systems or computing devices communicating via network 105. For example, network node 102 may be representative of a mobile device, a tablet, a desktop computer, connected devices, sensors, actuators, or any computing system having the capabilities described herein. Each network node 102 may include an agent (e.g., 110-1, 110-2 and 110-n) generally referred to as “agent 110” executing thereon. Agent 110 may be representative of a distributed intrusion detection agent configured to communicate with other agents to detect intrusion threats to the computing environment 100.

In some embodiments, agents 110 may be deployed across distinct network segments within the computing network environment 100. This deployment strategy allows for a distributed approach to intrusion detection, where each agent 110 is responsible for monitoring and analyzing network traffic within its assigned network segment. This distributed approach can enhance the scalability of the system, as the detection workload is distributed across multiple agents 110, allowing the system to handle increased traffic and devices as the network grows.

Each agent 110 may continuously monitor network traffic and analyze traffic patterns in real-time or near real-time. This continuous monitoring and analysis can enable the agents 110 to detect anomalies in the network traffic that may signify the early stages of an attack. By detecting these anomalies early, the system can potentially prevent substantial damage by allowing for quicker response times.

Furthermore, agents 110 are not isolated entities but are configured to communicate with other agents within the environment 100. This communication can facilitate the exchange of threat intelligence and collaborative refinement of intrusion detection models, enhancing the overall effectiveness of the system.

In some embodiments, computing environment 100 may further include server system 104 which may act as an application layer device by providing a high-level interface for the administration of the MARLEIDS, facilitating tasks such as configuration management, policy enforcement, and overall system monitoring.

As shown, server system 104 may communicate with one or more network nodes 102 via network 115 and network 105. Network 115 may be representative of any suitable type, including individual connections via the Internet, such as cellular or Wi-Fi networks. In some embodiments, network 105 may connect terminals, services, and mobile devices using direct connections, such as radio frequency RFID, NFC, Bluetooth™, BLE, Wi-Fi™, ZigBee™, ABC protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 115 may include any type of computer networking arrangement of network devices used to exchange data. For example, network 115 may be representative of the Internet, a private data network, virtual private network using a public network and/or other suitable connection(s) that enables components in computing environment 100 to send and receive information between the components of computing environment 100.

Server system 104 may be representative of an entity associated with agents 110. For example, server system 104 may be representative of a centralized or remote system that agents 110 may communicate with. In some embodiments, server system 104 may maintain a current overall state of the computing network.

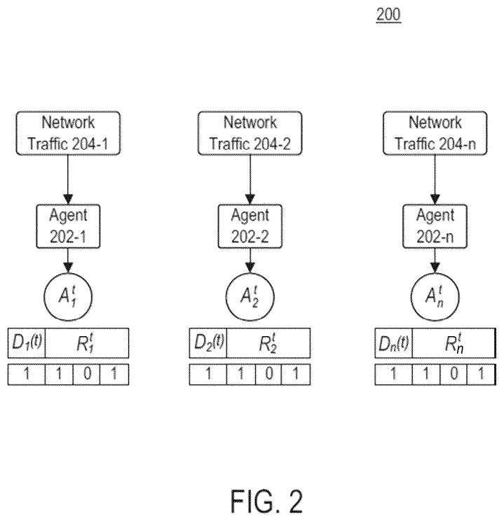

FIG. 2 is a block diagram illustrating agents deployed in a computing network 200, according to example embodiments. As shown, computing network 200 may include a plurality of agents 202-1, 202-2, 202-n (generally “agent 202” or “agents 202”). Agents 202 may be configured to continuously monitor portions of network traffic and analyze traffic patterns in real-time. By observing the network traffic in real-time, agents 202 can detect anomalies in the traffic patterns that may signify the early stages of an attack.

Each agent 202 may be equipped with a reinforcement learning algorithm that enables it to learn from the collected data (e.g. network traffic) patterns it observes. The reinforcement learning algorithm can allow agent 202 to adapt its detection strategies based on the feedback it receives from its localized environment. This continuous learning and adaptation process can enable Agent 202 to evolve its detection strategies as cyber threats evolve, ensuring that it remains effective in detecting new and unseen attacks.

Furthermore, the real-time analysis of collected data (e.g. network traffic) patterns can enable agents 202 to identify potential threats swiftly. By detecting anomalies that may signify the early stages of an attack, agents 202 can trigger an alert or initiate a response measure promptly, potentially preventing substantial damage to the network. The alert generated by an agent 202 upon detecting an anomaly may serve as a signal to other agents within the network. This alert can prompt the other agents to heighten their vigilance and adjust their monitoring parameters accordingly. By alerting other agents, the system ensures a coordinated response to potential threats, leveraging the collective intelligence and capabilities of the MARLEIDS to safeguard the network environment more effectively. This early detection and swift response capability can enhance the overall effectiveness of the MARLEIDS in protecting the network environment from cyber threats.

In some embodiments, the reinforcement learning algorithm used by agents 202 may be a multi-agent reinforcement learning algorithm. The multi-agent reinforcement learning algorithm enables agents 202 to adapt their detection strategies based on the feedback they receive from their localized environment. This continuous learning and adaptation process allows agents 202 to evolve their detection strategies as cyber threats evolve, ensuring that they remain effective in detecting new and unseen attacks.

Each agent 202 is assigned to a distinct network segment within the computing network. For example, as shown, agent 202-1 may monitor network traffic 204-1, agent 202-2 may monitor network traffic 204-2, and agent 202-n may monitor network traffic 204-n. This distributed deployment strategy allows for a scalable approach to intrusion detection, as the detection workload is distributed across multiple agents 202. As the network grows in size and complexity, additional agents 202 can be deployed to handle the increased traffic and devices, ensuring that the intrusion detection system remains efficient and effective.

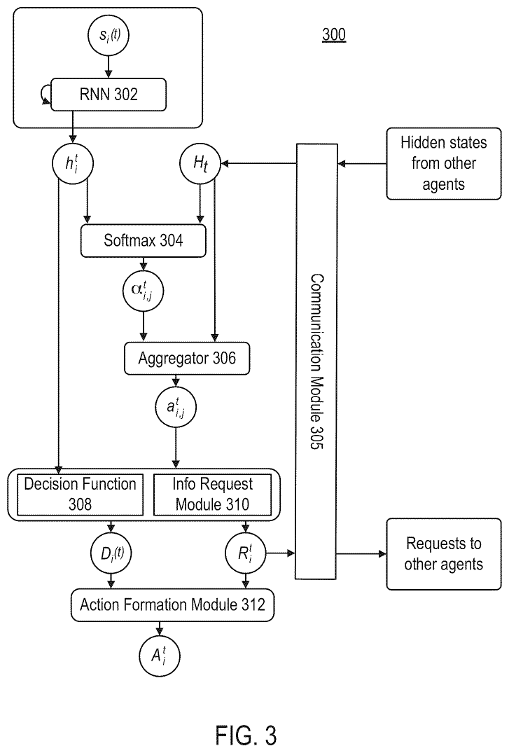

For ease of discussion, the following description of agent 202 may be explained over FIGS. 2 and 3 with reference to the example symbols, descriptions and representations shown in Table 1 below:

TABLE 1
(Example Reference Symbols, Descriptions and Representations for Describing the Agent)

| Symbol/Element | Description | Representation/Calculation |
|---|---|---|
| AGᵢ | Agent i | |
| AGⱼ | Another agent in the netwrok | |
| | distinct from AGᵢ | |
| ${s}_{i}^{( t )}$ | State observed by agent AGᵢ at a time t, represented by k features from the | ${s}_{i}^{( t )} = [ {f}_{1} , {f}_{2} , … , {f}_{k} ]$ |
| | network packet | |
| ${h}_{i}^{( t )}$ | Hidden state of agent AGᵢ at time t | ${h}_{i}^{( t )} = RNN ( {s}_{i}^{( t )} , {h}_{i}^{( t - 1 )} )$ |
| ${H}_{j}^{( t )}$ | Vector of hidden states received from agent AGⱼ at time t | ${H}_{j}^{( t )} = [ {h}_{j 1}^{( t )} , {h}_{j 2}^{( t )} , … , {h}_{jn}^{( t )} ]$ |
| ${α}_{ij}^{( t )}$ | Attention weight denoting the importance of agent AGⱼ's information for Agent AGᵢ at time t | ${α}_{ij}^{( t )} = softmax ( {h}_{i}^{( t )} \cdot {H}_{j}^{( t )} )$ |
| ${a}_{i}^{( t )}$ | Aggregated state information for agent AGᵢ using attention at time t | ${a}_{i}^{( t )} = {\sum }_{j} {α}_{ij}^{( t )} \times {H}_{j}^{( t )}$ |
| ${D}_{i}^{( t )}$ | Decision by agent AGᵢ at time t to detect an attact (1 for attack, 0 otherwise ) | ${D}_{i}^{( t )} = f ( {a}_{i}^{( t )} , {h}_{i}^{( t )} ) where f outposts 1 ( attack ) or 0 ( no attack )$ |
| ${R}_{i}^{( t )}$ | Request vector by agent AGᵢ at time t denoting which agents it requests information from | ${R}_{i}^{( t )} = g ( {a}_{i}^{( t )} , {h}_{i}^{( t )} ) where g is a function generating the request vector$ |
| ${A}_{i}^{( t )}$ | Action vector of agent AGᵢ at time t consisting of its decision and request vector | ${A}_{i}^{( t )} = [ {D}_{i}^{( t )} , {R}_{i}^{( t )} ]$ |
| A^{(t)} | Global Action Matrix at time t | ${A}^{( t )} = [ \begin{matrix}{A}_{1}^{( t )} \\ {A}_{2}^{( t )} \\ ⋮ \\ {A}_{n}^{( t )}\end{matrix} ]$ |

As shown, each agent 202 may observe a state sᵢ at a given time t. The collective state of the entire computing network 200 at a given time may be represented as S(t)=[s₁(t), s₂(t), . . . , sₙ(t)]. Based on observed states, each agent 202 may take an action, Aᵢ(t). Each action, Aᵢ(t) may include an indication of whether an attack was detected and an indication of those other agents 202 in computing network 200 that a given agent 202 may need more information from. Mathematically, this may be represented as Aᵢ(t)=(Dᵢ(t), Rᵢ(t)), where Dᵢ(t) is a binary value (e.g., 1 for any attack detected, 0 otherwise), and Rᵢ(t) is a binary vector representing request for information from other agents. The collective action of the intrusion detection system at time t may be represented as A(t)=[A₁(t),A₂(t), . . . , Aₙ(t)].

Once the request vector is generated, the vector serves as an indicator for communication pathways to other agents within the network. Specifically, the request vector of agent Aᵢ(t) contains binary indicators, where a value of 1 signifies that agent Aᵢ(t) communicates its detection results to the corresponding agent. It is to be noted that the request vector itself may not be communicated; rather, it determines the flow of detection results between agents. For example, an agent identified with a 1 in the request vector may receive the pertinent detection information from agent Aᵢ(t) facilitating a targeted and efficient exchange of relevant security data within the MARLEIDS framework. This communication can be facilitated through either broadcast or direct communication, depending on the architecture of the network and the specific requirements of the situation. In the case of broadcast communication, agent 202 may broadcast Dᵢ(t) to all agents in the network. Agents having a non-zero entry in the request vector understand that they are requested to send their hidden states back to broadcasting agent 202. Upon the generation of the request vector, designated as Rᵢ(t) by an agent, the vector serves as a communication signal to other agents within the network. The request vector Rᵢ(t) is formulated based on the attention weights calculated by the agent, which reflect the relevance of information from other agents in the network. The attention mechanism ensures that each agent selectively requests data that is deemed pertinent to its current detection task. The request vector Rᵢ(t) may contain binary indicators, where a value of 1, for example, signifies a request for the hidden state from the corresponding agent. The hidden state encapsulates the internal representation and knowledge of an agent regarding the network segment it monitors. When an agent receives a request vector with a non-zero entry corresponding to its identifier, it understands that its hidden state is requested and proceeds to send this information back to the requesting agent. This mode of communication can be particularly useful in scenarios where agent 202 requires information from multiple agents in the network simultaneously.

On the other hand, in the case of direct communication, agent 202 directly communicates with the specific agents identified by the non-zero entries in the request vector. This mode of communication can be more efficient in scenarios where agent 202 requires information from a specific agent or a small subset of agents in the network. Direct communication between agents within the MARLEIDS framework is particularly advantageous in scenarios where specific attack patterns, such as reconnaissance attacks, may precede and inform the likelihood of subsequent and more severe attacks like Distributed Denial of Service (DDoS) attacks. For example, an agent designated as Agent A may be specialized in detecting reconnaissance activities, which are typically characterized by an increase in internet control message protocol (ICMP) echo requests as attackers attempt to map the network topology. Upon detecting such a pattern, Agent A could directly communicate with another specialized agent, referred to as Agent B, which is responsible for detecting DDoS attacks. The direct communication between Agent A and Agent B is predicated on the understanding that reconnaissance attacks are often the harbingers of imminent DDoS attacks. By sharing its detection of increased reconnaissance activity, Agent A enables Agent B to preemptively adjust its monitoring parameters and heighten its vigilance for potential DDoS attack signatures. This targeted communication ensures that Agent B can prepare and respond more effectively to the evolving threat landscape, thereby enhancing the overall security posture of the network. This mode of communication is more efficient in such scenarios because it ensures that the information about potential threats is rapidly and accurately conveyed between the relevant agents, without the overhead of broadcasting to agents for which the information may not be pertinent. By leveraging direct communication, the MARLEIDS can orchestrate a coordinated and strategic defense against complex, multi-stage cyber threats, ensuring a proactive and dynamic response to cyber-attacks. Regardless of the mode of communication used, the communication process is designed to facilitate the exchange of information among the agents 202, enabling them to collaboratively refine their intrusion detection models and enhance the overall effectiveness of the intrusion detection system.

FIG. 3 is a block diagram illustrating an internal workflow 300 executed by a given agent (e.g., agent 202 in FIG. 2) for generating an action vector, according to example embodiments. As shown, the agent may observe a state sᵢ(t) that represents the current observations or the environment state for the agent at time t. State s₁(t) may be based on the portion of network traffic that the agent may be assigned. In some embodiments, the state sᵢ(t) may include temporal dynamics of observations over time. sᵢ(t) could include a set of network packet parts (e.g., header, payload, etc.) or some relevant data from application logs, etc. that are dependent on the type of attack that the agent is detecting. Based on state sᵢ(t), the agent may generate a hidden state hᵢ^{t} using a recurrent neural network (RNN) 302. The hidden state hᵢ^{t} may encapsulate the agent's understanding of the observed states in [0, t]. In some embodiments, RNN 302 may use the previous hidden state to influence the current hidden state. In other words, by utilizing RNN's 302 recurrence, the agent may, in effect, maintain a memory of past observations.

As shown, the agent may receive hidden states from other agents, i.e., Hₜ via a communication module 305 of the agent. In some embodiments, the agent may receive Hₜ via a broadcast from each other agent 202 in computing network 200. In some embodiments, agent 202 may receive Hₜ directly from other agents in computing network 200.

Based on the generated hidden state

$${h}_{i}^{t}$$

and the hidden state from other agents Hₜ, agent 202 may leverage its attention mechanism to focus on specific hidden states from other agents based on its own current state. The attention mechanism may be formed from a Softmax layer (hereinafter Softmax 304) and aggregation layer (hereinafter aggregation 306). The Softmax 304 and aggregation 306 may work in conjunction to generate a weighted combination of the current hidden state

$${h}_{i}^{t}$$

and hidden states of other agents H^{t}, which may be referred to as the attended hidden state

$${a}_{i , j}^{t} , where {a}_{i , j}^{t} = {\sum }_{j} {α}_{i , j}^{t} \times {H}_{j}^{t} .$$

The Softmax 304 and aggregation 306 may work in conjunction to further generate weights that dictate agent's 202 request for information (or context) from other agents in computing network 200. The weights may be denoted as

$${α}_{i , j}^{t} , where {α}_{i , j}^{t} = Soft max ( {h}_{i}^{t} \cdot {H}_{j}^{t} )$$

where the ‘Softmax’ is a function that converts a vector of values into values between 0 and 1 that can be used as the attention weights for the weighted combination described above.

Using the attended hidden state

$${a}_{i , j}^{t}$$

and its own current hidden state

$${h}_{i}^{t} ,$$

the agent may leverage a decision function 308 to decide if there is an attack or not based on Dᵢ(t). In some embodiments, the action may be a specific detection. In some embodiments, decision function 308 may be represented as:

$$f ( {a}_{i , j}^{t} , {h}_{i}^{t} ) = σ ( {w}^{T} \cdot [ {a}_{i , j}^{t} , {h}_{i}^{t} ] + b )$$

where

$$σ ( z ) = \frac{1}{1 + {e}^{- z}} ,$$

w is a weight vector, b is a scalar bias. The output may be a probability value, which may be thresholded. For example, if the output exceeds a predefined threshold, e.g., θ, the state may be classified as an attack. Mathematically, this may be represented as:

$${D}_{i} ( t ) = \{ \begin{matrix}1 if f ( {a}_{i , j}^{t} , {h}_{i}^{t} ) > θ \\ 0 otherwise\end{matrix}$$

It is noted that the sigmoid function is an activation function in the fields of neural networks and logistic regression. It plays a role in transforming the linear combination of inputs into a value that falls within a specific range, typically between 0 and 1. This characteristic makes it particularly useful for binary classification tasks. Within the context of the sigmoid function, the terms “z” and “b” are of central relevance and are defined as follows. The term “z” represents the linear combination of the input features and their corresponding weights. The computation of “z” is achieved through the dot product of the weights and input features, to which the bias term “b” is added. The result of this computation, “z,” is then passed through the sigmoid function to produce an output that can be interpreted probabilistically in the case of logistic regression, or as an activation in the case of neural networks. The term “b” stands for the bias term in the equation. It is a constant value that is added to the linear combination of weights and input features. The inclusion of the bias term is instrumental in the model's ability to accurately represent the data. By adjusting the bias term, the model gains an additional degree of freedom, which can be optimized during the training process to improve the fit of the model to the data. The bias term ensures that the model can make accurate predictions even when the input features have values of zero. The “z” and “b” terms are used by the sigmoid function to map the input data to an output that is suitable for binary classification tasks in logistic regression and for determining the activation levels in neural networks.

The agent may further leverage information request module 310 to determine other agents the agent should communicate with. For example, information request module 310 may generate information request vector

$${R}_{i}^{t}$$

as follows:

$${R}_{i}^{t} = g ( {a}_{i , j}^{t} , {h}_{i}^{t} ) = Thre shold ( W \cdot [ {a}_{i , j}^{t} , {h}_{i}^{t} ] + c )$$

where W represents the weight matrix of size

$$n \times ( \vert {a}_{i , j}^{t} \vert + \vert {h}_{i}^{t} \vert )$$

and c is the bias vector of size n. Furthermore, the threshold function may be applied elementwise and may be defined by:

$$Threshold ( x ) = \{ \begin{matrix}1 & if x > y \\ 0 & otherwise\end{matrix}$$

with γ being a predetermined threshold value. The request vector

$${R}_{i}^{t}$$

may indicate signals to other agents indicating the need for further information or context from those agents.

Action formation module 312 may be configured to combine the decided action

$${D}_{i}^{t}$$

with other elements (e.g.,

$${R}_{i}^{t} )$$

to form the final action vector

$${A}_{i}^{t} .$$

Once the request vector

$${R}_{i}^{t}$$

is generated, the agent may broadcast it to all other agents in computing network 200 or may directly communicate with specific agents. In those embodiments in which the agent broadcasts the request vector, agents receiving a non-zero entry in the request vector understand that they are required to send their hidden states back to the sending agent. In those embodiments, in which the agent directly communicates with specific agents, the agent may identify those other agents by the non-zero entries in

$${R}_{i}^{t} .$$

Upon receiving the hidden states from other agents, the agent may update its aggregated state,

$${a}_{i}^{t} ,$$

recalculate its attention weights,

$${α}_{i , j}^{t} ,$$

and update its decision Dᵢ(t) based on the new information. If the decision Dᵢ(t) changes or if there is additional relevant information, agent 202 can send feedback or updates to other agents, as discussed above.

When all agents have generated their respective action vectors, these vectors may be compiled into a global action matrix A^{t}, such that:

$${A}^{t} = [ \begin{matrix}{A}_{1}^{t} \\ {A}_{2}^{t} \\ . \\ . \\ . \\ {A}_{n}^{t}\end{matrix} ]$$

As agents experience and analyze more and more information, the agents may undergo a reinforcement learning process, in which the agents' attention mechanisms can continually learn and adapt to new and unseen threats. Such a learning process may ensure that as cyberattack strategies evolve, the distributed intrusion detection system is not left behind but rather updates its knowledge to identify and counteract novel attack patterns.

When an attack is detected by an agent within the MARLEIDS, the agent takes action to mitigate the threat. The agent generates an alert that encapsulates the details of the detected attack, including the type of attack, the affected network segment, and the time of detection. This alert is then communicated to other agents and the central server system, if present, to inform them of the incident. Concurrently, the agent may also initiate predefined response protocols, which could include isolating the affected network segment, blocking suspicious IP addresses, or deploying countermeasures such as rate limiting or captcha challenges to thwart the attack. The agent's response is recorded and fed back into the reinforcement learning algorithm, allowing the system to learn from the incident and refine its detection and response strategies for future threats. This ensures that the system not only reacts to current attacks but also evolves its defenses to stay ahead of emerging cyber threats.

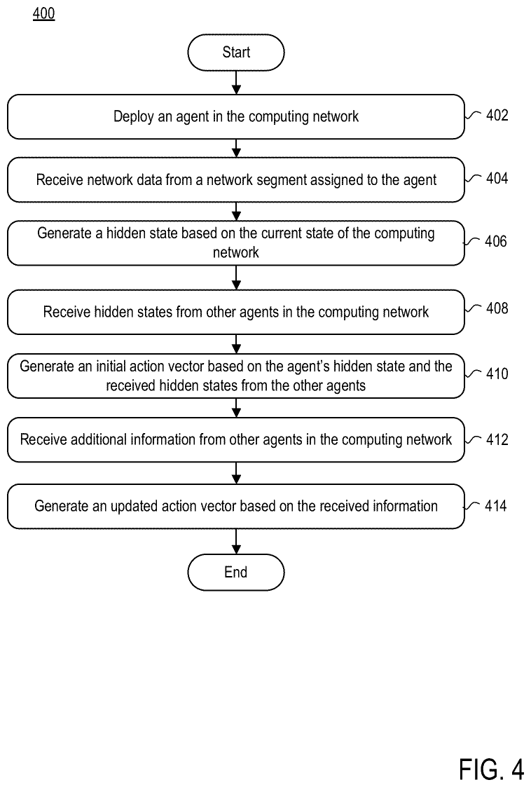

FIG. 4 is a flow diagram illustrating method 400 of detecting an attack to a computing network using distributed intrusion detection agents, according to example embodiments. Method 400 may begin at step 402.

At step 402, an agent, AGᵢ, may be deployed within the computing network. For example, the computing network may include a plurality of network nodes. The network nodes may be representative of one or more computing systems, such as, but not limited to, a mobile device, a tablet, a desktop computer, connected devices, sensors, and actuators. Each network node may include an agent executing thereon. The agent, AGᵢ, may be representative of a distributed intrusion detect agent configured to communicate with other agents for the purpose of detecting intrusion threats to the computing network. Each agent is responsible for monitoring and analyzing network traffic within its assigned network segment.

At step 404, agent AGᵢ may receive network data. For example, as discussed above, each agent may be assigned a segment of the computing network to monitor. In operation, agent AGᵢ may receive network data in real-time or near real-time. For example, at each time t, agent AGᵢ may monitor and analyze network traffic within its assigned network segment. At any given time t, the agent may observe a state s(t).

At step 406, agent AGᵢ may generate a hidden state

$${h}_{i}^{t}$$

based on the current state s(t) of the computing network. For example, based on state sᵢ(t), agent AGᵢ may generate a hidden state

$${h}_{i}^{t}$$

using an RNN. The hidden state

$${h}_{i}^{t}$$

may encapsulate agent's AGᵢ understanding of the observed states in [0, t]. In some embodiments, the RNN may use the previous hidden state to influence the current hidden state. In other words, by utilizing RNN's recurrence, agent AGᵢ may, in effect, maintain a memory of past observations.

At step 408, agent AGᵢ may receive hidden states from other agents Hₜ. For example, agent AG₁ may receive a first hidden state

$${h}_{2}^{t}$$

from agent AG₂ and a second hidden state

$${h}_{3}^{t}$$

from agent AG₃. The first hidden state

$${h}_{2}^{t}$$

and the second hidden state

$${h}_{3}^{t}$$

may be aggregated to form the hidden state vector Hₜ, representing the hidden states of other agents in the computing network. In some embodiments, agent AGᵢ may receive the other hidden states Hₜ via a broadcast from each other agent in the computing network. In some embodiments, agent AGᵢ may receive the other hidden states Hₜ through direct messages from the other agents in the computing network.

At step 410, agent AGᵢ may generate an initial action vector, Aᵢ(t) based on its hidden state

$${h}_{i}^{t}$$

and the hidden state from other agents Hₜ. The initial action vector Aᵢ(t) may include an indication of whether an attack was detected and an indication of those other agents in computing network that agent Aᵢ(t) may include an indication of whether an attack was detected and an indication of those other agents in the computing network that a given agent may need more information from in order to assess whether an attack is detected. Mathematically, this may be represented as Aᵢ(t)=(Dᵢ(t), Rᵢ(t)), where Dᵢ(t) is a binary value (e.g., 1 for any attack detected, 0 otherwise), and Rᵢ(t) is a binary vector representing a request for information from other agents the agent may need more information from.

In some embodiments, to generate the action vector Aᵢ(t), agent Aᵢ(t) may leverage its attention mechanism to focus on specific hidden states from other agents based on its own current state. The attention mechanism may be formed from a Softmax layer and an aggregation layer. The Softmax layer and aggregation layer may work in conjunction to generate a weighted combination of the current hidden state

$${h}_{i}^{t}$$

and hidden states of other agents H^{t}, which may be referred to as the attended hidden state

$${a}_{i , j}^{t} , where {a}_{i , j}^{t} = {\sum }_{j} {α}_{i , j}^{t} \times {H}_{j}^{t} .$$

The Softmax layer and aggregation layer may work in conjunction to further generate weights that dictate agent's AGᵢ request for information (or context) from other agents in the computing network.

Using the attended hidden state

$${a}_{i , j}^{t}$$

and its own current hidden state

$${h}_{i}^{t} ,$$

agent AGᵢ may leverage a decision function to decide on an action, denoted as Dᵢ(t). In some embodiments, the action may be a specific detection or other appropriate action based on the context. The value corresponding to the action may represent a threshold probability value of an attack being detected. Agent AGᵢ may further leverage the information request module to determine other agents that agent AGᵢ should communicate with. For example, an information request module may generate an information request vector

$${R}_{i}^{t}$$

that indicates to the other agents the need for further information or context from a subset of the other agents.

The combination of the decision vector and request vector may form the initial action vector.

At step 412, agent AGᵢ may receive hidden states from other agents. In some embodiments, agent AGᵢ may broadcast to all other agents in the computing network the request vector to prompt a subset of the other agents for additional information. For example, agents for which there is a non-zero entry in the request vector may understand that they are required to send their hidden states back to the requesting agent. In some embodiments, agent AGᵢ may directly communicate with those agents that have non-zero entries in the request vector.

At step 414, agent AGᵢ may generate an updated action vector

$${\hat{A}}_{i}^{t}$$

based on the received information from the other agents. For example, agent AGᵢ may update its aggregated state,

$${a}_{i}^{t} ,$$

recalculate its attention weights,

$${α}_{i , j}^{t} ,$$

and update its decision Dᵢ(t) based on the new information. If the decision Dᵢ(t) changes or if there is additional relevant information, agent AGᵢ can send feedback or updates to other agents, as discussed above.

When all agents have generated their respective action vectors, these vectors are compiled into the global action matrix, denoted as A(t). In some embodiments, the global action matrix A(t), may be broadcast across the computing network and/or maintained internally by each agent AGᵢ.

In some embodiments, agents may use the outcomes and feedback from global action matrix A(t) to update and refine their internal models, improving their future detection and communication actions. This continuous learning and adaptation process allows the distributed intrusion detection system to remain effective even as cyber threats evolve, ensuring high detection accuracy and swift threat identification.

It is noted that although the system is described as monitoring network traffic, it could also monitor other types of data including but not limited to one or a combination of logs and other data as described below. For example, system logs can provide insights into system events, security incidents, and operational anomalies. Application logs are another source of information, that may reveal unusual application behavior, access violations, or attempts to exploit application vulnerabilities. In addition, an authentication record may play a role in the detection of unauthorized access attempts, brute-force attacks, or compromised credentials. The monitoring of configuration changes may also be of interest as it can indicate unauthorized modifications to system settings or network infrastructure. Moreover, file integrity monitoring data may be an indicator of unauthorized changes to system files or directories. In Windows environments, for example, registry settings may also be sensitive to monitoring, as changes may suggest system tampering or malware installation. Process monitoring data is also capable of identifying suspicious or malicious processes running on the system. Network flow data provides a higher-level view of network traffic patterns, which may be used in identifying large-scale data transfers or unusual communication patterns. Anomaly detection in user behavior is a tool that can detect insider threats or compromised user accounts by observing deviations from normal usage patterns. Likewise, database activity monitoring can uncover attempts to access or exfiltrate sensitive data, SQL injection attacks, or other database-related security breaches. Cloud services monitoring may also be relevant, tracking usage and access to cloud-based resources and services to detect potential security incidents in cloud environments. Endpoint detection and response (EDR) data offers detailed information about endpoint activity, including file access, network connections, and binary executions. Intrusion prevention system (IPS) alerts, when correlated with other data sources, may provide a more comprehensive view of potential security incidents. Lastly, vulnerability scan results are a proactive measure used to identify and prioritize potential weaknesses in the network that may be exploited by attackers.

It is noted that MARLEIDS exhibits superior performance characteristics when compared to traditional models. One of the standout features of the MARLEIDS is its low latency in detecting potential threats. In simulations, MARLEIDS exhibits latency of less than 5 milliseconds, which is an order of magnitude faster than an average model, which typically takes around 50 milliseconds, and far surpasses poor models with latencies of 200 milliseconds. This rapid detection capability is beneficial in a cybersecurity landscape where every millisecond can mean the difference between a successfully thwarted attack and a costly data breach. In addition to its impressive latency, simulations have shown that the MARLEIDS also boasts a swift convergence time of less than 3 milliseconds. This is an improvement over average models, which take more than twice as long at approximately 7 milliseconds, and poor models, which lag behind at 10 milliseconds. The convergence time is a measure of how quickly the system can adapt to new data and update its detection strategies, which is a testament to the efficiency of the MARLEIDS' learning algorithms. The distributed processing nature of the MARLEIDS further enhances its performance. Unlike traditional Intrusion Detection Systems (IDSs) that process network traffic centrally—often leading to delays due to bottlenecks—the MARLEIDS allows each agent to process data independently. This decentralized approach not only speeds up detection but also scales more effectively as network size and complexity increase. Another advantage of the MARLEIDS is the ability of its agents to learn from peers. This collaborative learning mechanism enables the system to adapt quickly to emerging threats. When one agent detects an attack, it can immediately communicate this information to other agents, thereby enhancing the detection speed across the network. This peer-to-peer communication ensures that the collective knowledge of the system is greater than the sum of its parts. Lastly, the real-time adaptation of the MARLEIDS is beneficial in the field of cybersecurity. The system's use of reinforcement learning allows it to recognize and respond to novel threats more quickly than traditional systems, which might rely on periodically updated signatures. This means that the MARLEIDS is not just reactive but also proactive, continuously evolving to anticipate and counteract the ever-changing tactics of cyber adversaries.

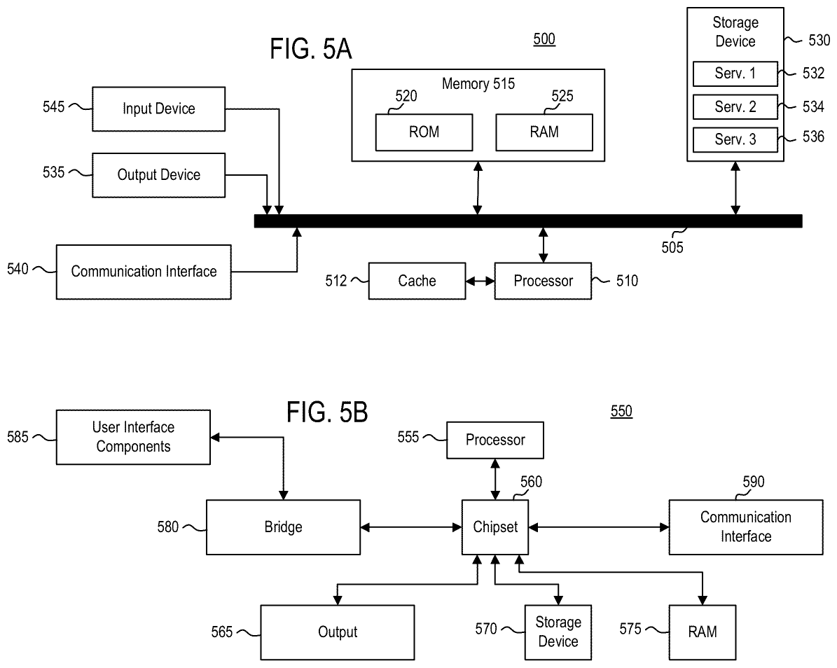

FIG. 5A illustrates an architecture of computing system 500, according to example embodiments. One or more components of system 500 may be in electrical communication with each other using a bus 505. System 500 may include a processor (e.g., one or more CPUs, GPUs or other types of processors) 510 and a bus 505 that couples various system components including the system memory 515, such as read only memory (ROM) 520 and random-access memory (RAM) 525, to processor 510. System 500 can include a cache of high-speed memory connected directly with, close to, or integrated as part of processor 510. System 500 can copy data from memory 515 and/or storage device 530 to cache 512 for quick access by processor 510. In this way, cache 512 may provide a performance boost that avoids processor 510 delays while waiting for data. These and other modules can control or be configured to control processor 510 to perform various actions. Another system memory 515 may be available for use as well. Memory 515 may include multiple different types of memory with different performance characteristics. Processor 510 may be representative of a single processor or multiple processors. Processor 510 can include one or more of a general-purpose processor or a hardware module or software module, such as service 1 532, service 2 534, and service 3 536 stored in storage device 530, configured to control processor 510, as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction with the system 500, an input device 545 can be any number of input mechanisms, such as a microphone for speech, a touch-sensitive screen for gesture or graphical input, keyboard, mouse, motion input, speech and so forth. An output device 535 (e.g., a display) can also be one or more of several output mechanisms known to those of skill in the art. In some instances, multimodal systems can enable a user to provide multiple types of input to communicate with system 500. Communication interface 540 can generally govern and manage the user input and system output. There is no restriction on operating on any hardware arrangement and therefore the basic features here may easily be substituted for improved hardware or firmware arrangements as they are developed.

Storage device 530 may be a non-volatile memory and can be a hard disk or other type of computer readable media that can store data that are accessible by a computer, such as magnetic cassettes, flash memory cards, solid state memory devices, digital versatile disks, cartridges, random access memories (RAMs) 525, read only memory (ROM) 520, and hybrids thereof.

Storage device 530 can include services 532, 534, and 536 for controlling the processor 510. Other hardware or software modules are contemplated. Storage device 530 can be connected to system bus 505. In one aspect, a hardware module that performs a particular function can include the software component stored in a non-transitory computer-readable medium in connection with the necessary hardware components, such as processor 510, bus 505, output device 535 (e.g., a display), and so forth, to carry out the function.

FIG. 5B illustrates computer system 550 having a chipset architecture, according to example embodiments. Computer system 550 may be an example of computer hardware, software, and firmware that can be used to implement the disclosed technology. System 550 can include one or more processors 555, representative of any number of physically and/or logically distinct resources capable of executing software, firmware, and hardware configured to perform identified computations. One or more processors 555 can communicate with a chipset 560 that can control input to and output from one or more processors 555. In this example, chipset 560 outputs information to output 565, such as a display, and can read and write information to storage device 570, which can include magnetic media, and solid-state media, for example. Chipset 560 can also read data from and write data to storage device 575 (e.g., RAM). A bridge 580 for interfacing with a variety of user interface components 585 can be provided for interfacing with chipset 560. Such user interface components 585 can include a keyboard, a microphone, touch detection and processing circuitry, a pointing device, such as a mouse, and so on. In general, inputs to system 550 can come from any of a variety of sources, machine generated and/or human generated.

Chipset 560 can also interface with one or more communication interfaces 590 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by one or more processors 555 analyzing data stored in storage device 570 or 575. Further, the machine can receive inputs from a user through user interface components 585 and execute appropriate functions, such as browsing functions by interpreting these inputs using one or more processors 555.

It can be appreciated that example systems 500 and 550 can have more than one processor 510 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method of detecting an intrusion attack to a computing network, comprising:
initiating, by a node of the computing network, a distributed intrusion detection agent, the distributed intrusion detection agent configured to communicate with a plurality of other distributed intrusion detection agents executing across a plurality of other nodes of the computing network, each of the node and the plurality of other nodes assigned to distinct network segments of the computing network;
monitoring, by the distributed intrusion detection agent, network activity of a network segment assigned to the distributed intrusion detection agent;
generating, by the distributed intrusion detection agent, an initial action vector using one or more reinforcement learning techniques, the initial action vector comprising a first indication of whether an attack was detected and a second indication defining a subset of the plurality of other nodes the node requires further information from;
broadcasting, by the distributed intrusion detection agent, the initial action vector across the computing network;
receiving, by the distributed intrusion detection agent, the further information from the subset of the plurality of other nodes; and
updating, by the distributed intrusion detection agent, the initial action vector based on the further information to generate an updated action vector comprising an updated first indication of whether an attack was detected.

2. The method of claim 1, wherein generating, by the distributed intrusion detection agent, the initial action vector comprises:
generating, via a recurrent neural network, a hidden state based on the network activity of the network segment assigned to the distributed intrusion detection agent, the hidden state representing a current understanding of the network activity based on previous observed states.

3. The method of claim 2, further comprising:
receiving a plurality of other hidden states from the plurality of other distributed intrusion detection agents in the computing network.

4. The method of claim 3, further comprising:
leveraging an attention mechanism comprising a Softmax layer and an aggregation layer to focus on specific hidden states from the plurality of other distributed intrusion detection agents, wherein the attention mechanism generates a weighted combination of the hidden state and the plurality of other hidden states.

5. The method of claim 1, wherein generating, by the distributed intrusion detection agent, the initial action vector comprises:
determining a probability of whether an attack was detected based on the network activity.

6. The method of claim 1, further comprising:
receiving, by the distributed intrusion detection agent, a plurality of other updated action vectors from the plurality of other distributed intrusion detection agents.

7. The method of claim 6, further comprising:
updating and refining, by the distributed intrusion detection agent, the one or more reinforcement learning techniques based on the plurality of other updated action vectors.

8. A non-transitory computer readable medium comprising programming instructions, which, when executed by a processor, causes a node of a computing network to perform operations comprising:
initiating, by the node of the computing network, a distributed intrusion detection agent, the distributed intrusion detection agent configured to communicate with a plurality of other distributed intrusion detection agents executing across a plurality of other nodes of the computing network, each of the node and the plurality of other nodes assigned to distinct network segments of the computing network;
monitoring, by the distributed intrusion detection agent, network activity of a network segment assigned to the distributed intrusion detection agent;
generating, by the distributed intrusion detection agent, an initial action vector using one or more reinforcement learning techniques, the initial action vector comprising a first indication of whether an attack was detected and a second indication defining a subset of the plurality of other nodes the node requires further information from;
broadcasting, by the distributed intrusion detection agent, the initial action vector across the computing network;
receiving, by the distributed intrusion detection agent, the further information from the subset of the plurality of other nodes; and
updating, by the distributed intrusion detection agent, the initial action vector based on the further information to generate an updated action vector comprising an updated first indication of whether an attack was detected.

9. The non-transitory computer readable medium of claim 8, wherein generating, by the distributed intrusion detection agent, the initial action vector comprises:
generating, via a recurrent neural network, a hidden state based on the network activity of the network segment assigned to the distributed intrusion detection agent, the hidden state representing a current understanding of the network activity based on previous observed states.

10. The non-transitory computer readable medium of claim 9, further comprising:
receiving a plurality of other hidden states from the plurality of other distributed intrusion detection agents in the computing network.

11. The non-transitory computer readable medium of claim 10, further comprising:
leveraging an attention mechanism comprising a Softmax layer and an aggregation layer to focus on specific hidden states from the plurality of other distributed intrusion detection agents, wherein the attention mechanism generates a weighted combination of the hidden state and the plurality of other hidden states.

12. The non-transitory computer readable medium of claim 8, wherein generating, by the distributed intrusion detection agent, the initial action vector comprises:
determining a probability of whether an attack was detected based on the network activity.

13. The non-transitory computer readable medium of claim 8, further comprising:
receiving, by the distributed intrusion detection agent, a plurality of other updated action vectors from the plurality of other distributed intrusion detection agents.

14. The non-transitory computer readable medium of claim 13, further comprising:
updating and refining, by the distributed intrusion detection agent, the one or more reinforcement learning techniques based on the plurality of other updated action vectors.

15. A system comprising:
a processor; and
a memory comprising:
a distributed intrusion detection agent configured to execute on a node of the computing network to communicate with a plurality of other distributed intrusion detection agents executing across a plurality of other nodes of the computing network, each of the distributed intrusion detection agent and the plurality of other distributed intrusion detection agents assigned to distinct network segments of the computing network, and
programming instructions stored thereon, the programming instructions, which, when executed by the processor, causes the distributed intrusion detection agent to perform operations comprising:
monitoring, by the distributed intrusion detection agent, network activity of a network segment assigned to the distributed intrusion detection agent;
generating, by the distributed intrusion detection agent, an initial action vector using one or more reinforcement learning techniques, the initial action vector comprising a first indication of whether an attack was detected and a second indication defining a subset of the plurality of other intrusion detection agents the intrusion detection agent requires further information from;
broadcasting, by the distributed intrusion detection agent, the initial action vector across the computing network;
receiving, by the distributed intrusion detection agent, the further information from the subset of the plurality of other intrusion detection agents; and
updating, by the distributed intrusion detection agent, the initial action vector based on the further information to generate an updated action vector comprising an updated first indication of whether an attack was detected.

16. The system of claim 15, wherein generating, by the distributed intrusion detection agent, the initial action vector comprises:
generating, via a recurrent neural network, a hidden state based on the network activity of the network segment assigned to the distributed intrusion detection agent, the hidden state representing a current understanding of the network activity based on previous observed states.

17. The system of claim 15, further comprising
receiving a plurality of other hidden states from the plurality of other distributed intrusion detection agents in the computing network; and
leveraging an attention mechanism comprising a Softmax layer and an aggregation layer to focus on specific hidden states from the plurality of other distributed intrusion detection agents, wherein the attention mechanism generates a weighted combination of the hidden state and the plurality of other hidden states.

18. The system of claim 15, wherein generating, by the distributed intrusion detection agent, the initial action vector comprises:
determining a probability of whether an attack was detected based on the network activity.

19. The system of claim 15, further comprising:
receiving, by the distributed intrusion detection agent, a plurality of other updated action vectors from the plurality of other distributed intrusion detection agents.

20. The system of claim 19, further comprising:
updating and refining, by the distributed intrusion detection agent, the one or more reinforcement learning techniques based on the plurality of other updated action vectors.
